(19) United States
(12) Patent Application Publication
(10) Pub. No.: US 2019/0004624 A1
(43) Pub. Date: Jan. 3, 2019

(54) TOUCH SUBSTRATE AND MANUFACTURING METHOD THEREOF, TOUCH PANEL AND TOUCH DISPLAY DEVICE

(71) Applicants: BOE TECHNOLOGY GROUP CO., LTD., Beijing (CN); HEFEI XINSHENG OPTOELECTRONICS TECHNOLOGY CO., LTD., Hefei, Anhui (CN)

(72) Inventors: Kongshuo ZHU, Beijing (CN); Ming ZHANG, Beijing (CN); Ming HU, Beijing (CN); Xiaodong XIE, Beijing (CN)

(21) Appl. No.: 15/747,704

(22) PCT Filed: Jul. 18, 2017
(86) PCT No.: PCT/CN2017/093331

§ 371 Date: Jan. 25, 2018

(30) Foreign Application Priority Data
Aug. 1, 2016 (CN) 201610622091.1

(51) Int. Cl. G06F 3/044

(52) U.S. Cl. CPC G06F 3/044; G06F 2203/04103; G06F 2203/04111

(57) ABSTRACT

A touch substrate and a manufacturing method thereof, a touch panel and a touch display device. The touch substrate includes a transparent base substrate, including a touch region and a peripheral region; a first touch electrode and a second touch electrode intersected with and insulated from each other, and disposed in the touch region on the transparent base substrate; a first lead wire and a second lead wire, disposed in the peripheral region on the transparent base substrate, and connected with two ends of the first touch electrode respectively; and a first connection line, connecting the first lead wire and the second lead wire which are connected with the first touch electrode.

### TECHNICAL FIELD

The present disclosure relates to a touch substrate and a manufacturing method thereof, a touch panel and a touch display device.

### BACKGROUND

With the rapid development of the display technology, touch panels have been gradually used throughout people's lives. A manufacturing method of a touch panel can comprise the in-cell process (a process of integrating the touch panel to the internal of a display panel), the on-cell process (a process of attaching the touch panel to the external of the display panel) and the OGS (One Glass Solution) process (a process of integrating a touch electrode to a glass cover plate).

### SUMMARY

An embodiment of the disclosure provides a touch substrate, comprising: a transparent base substrate, including a touch region and a peripheral region surrounding the touch region; a first touch electrode and a second touch electrode, intersected with and insulated from each other, and disposed in the touch region on the transparent base substrate; a first lead wire and a second lead wire, disposed in the peripheral region on the transparent base substrate, the first lead wire being connected with an end of the first touch electrode, and the second lead wire being connected with another end of the first touch electrode; and a first connection line, connecting the first lead wire and the second lead wire which are connected with the first touch electrode, wherein the peripheral region comprises a bond region for bonding to a flexible printed circuit board and the first connection line is disposed in the bond region on the transparent base substrate.

In some examples, the first lead wire, the second lead wire and the first connection line are provide in a same layer and are made of a same material.

In some examples, the touch substrate further comprises: a third lead wire and a fourth lead wire, disposed in the peripheral region on the transparent base substrate, the third lead wire being connected with an end of the second touch electrode, and the fourth lead wire being connected with another end of the second touch electrode; and a fourth connection line, connecting the third lead wire and the fourth lead wire which are connected with the second touch electrode, and disposed in the bond region on the transparent base substrate.

In some examples, the first lead wire, the second lead wire, the third lead wire and the fourth lead wire are disposed in the same layer and are made of the same material, and the first connection line and the second connection line are disposed in different layers and are insulated from each other.

In some examples, a bond pin is disposed on a connection position where the first lead wire is connected with the first connection line, and the bond pin is disposed on a connection position where the second lead wire is connected with the first connection line.

In some examples, the first lead wire and the second lead wire share one bond pin.

In some examples, a bond pin is disposed on a connection position where the third lead wire is connected with the second connection line, and the bond pin is disposed on a connection position where the fourth lead wire is connected with the second connection line.

In some examples, the first lead wire and the second lead wire share one bond pin.

Another embodiment of the disclosure provides a touch panel, comprising the touch substrate as mentioned above, wherein a flexible printed circuit board is bonded to the bond region of the touch substrate.

Another embodiment of the disclosure provides a touch display device, comprising: the touch panel of claim as mentioned above; and a display panel, wherein the touch panel is provided on a light emitting side of the display panel.

Another embodiment of the disclosure provides a manufacturing method of a touch substrate, comprising: providing a transparent base substrate, which includes a touch region and a peripheral region surrounding the touch region; forming a first touch electrode and a second touch electrode in the touch region on the transparent base substrate, the first touch electrode and the second touch electrode being intersected with and insulated from each other; forming a first lead wire and a second lead wire in the peripheral region on the transparent base substrate, wherein the first lead wire is connected with an end of the first touch electrode, and the second lead wire is connected with another end of the first touch electrode; and forming a first connection line in the bond region on the transparent base substrate, the first connection line connecting the first lead wire and the second lead wire which are connected with the first touch electrode.

In some examples, the manufacturing method further comprises: forming a third lead wire and a fourth lead wire in the peripheral region on the transparent base substrate, wherein the third lead wire is connected with an end of the second touch electrode, and the fourth lead wire is connected with another end of the second touch electrode; and forming a second connection line in the bond region on the transparent base substrate, the second connection line connecting the third lead wire and the fourth lead wire which are connected with the second touch electrode.

Embodiments of the disclosure provides a touch substrate and a manufacturing method thereof, a touch panel and a touch display device, which can decrease a thickness of a flexible printed circuit board which is connected with the touch panel.

### BRIEF DESCRIPTION OF THE DRAWINGS

In order to clearly illustrate the technical solution of the embodiments of the invention, the drawings of the embodiments will be briefly described in the following; it is obvious that the described drawings are only related to some embodiments of the invention and thus are not limitative of the invention.

FIG. 1A is a structural schematic diagram of a touch panel;

FIG. 1B is a cross-section view along a line O-O of FIG. 1A;

FIG. 1C is a structural schematic diagram of a flexible printed circuit board of FIG. 1A;

FIG. 2 is a structural schematic diagram of a touch substrate provided by an embodiment of the disclosure;

FIG. 3 is a structural schematic diagram of another touch substrate provided by an embodiment of the disclosure;

FIG. 4 is a structural schematic diagram of a touch substrate which is provided with bond pins in a bond region of FIG. 3;

FIG. 5 is a structural schematic diagram of a touch panel provided by an embodiment of the disclosure; and

FIG. 6 is a flow chart of a manufacturing method of a touch substrate provided by an embodiment of the disclosure.

### DETAILED DESCRIPTION

In order to make objects, technical details and advantages of the embodiments of the invention apparent, the technical solutions of the embodiments will be described in a clearly and fully understandable way in connection with the drawings related to the embodiments of the invention. Apparently, the described embodiments are just a part but not all of the embodiments of the invention. Based on the described embodiments herein, those skilled in the art can obtain other embodiment(s), without any inventive work, which should be in the scope of the invention.

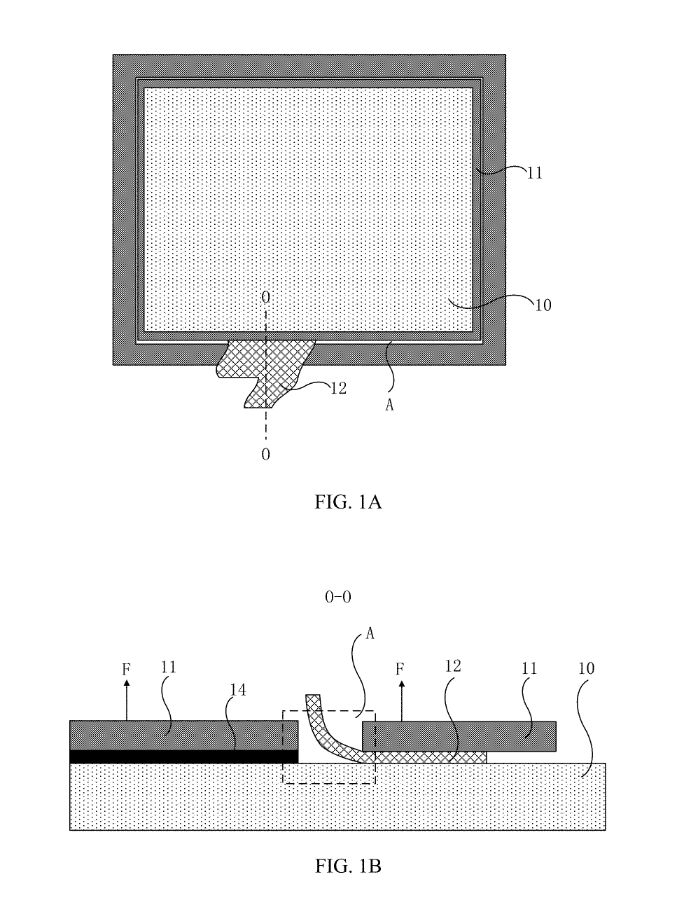

When a glass cover manufactured by the OGS process and a display panel are assembled, as illustrated in FIG. 1A, a frame 11 (Bezel) is usually assembled on the glass cover 10. The frame 11 is illustrated as FIG. 1B, and is Fixed on the glass cover 10 by adhesive. In addition, in order to drive touch electrodes integrated on the glass cover 10, a flexible printed circuit board 12 (FPC) is further amounted on the glass cover 10. The flexible printed circuit board 12 can pass through an opening A provided on the frame 11 and is connected with a motherboard (not shown in figures) after bending.

In addition, for a mutual capacitance type touch panel, in order to make the amount of the charges input to two ends of the touch electrode horizontally or vertically arranged be equal, as illustrated in FIG. 1C, a connection line 13 for connecting two ends of the touch electrode is usually provided on the flexible printed circuit board 12. In addition, the flexible printed circuit board 12 is further provided with a plurality of lead wires (not shown in figures) for connecting a drive element on the motherboard and the touch electrode integrated on the glass cover 10. In order to avoid the signal crosstalk between the lead wire and the connection line, the above mentioned lead wire and the connection line are required to be provided in different layers, and thus a thickness of the flexible printed circuit board 12 is large. In such a way, as illustrated in FIG. 1B, when the flexible printed circuit board 12 is passed through the opening A, a large pull force F to the frame 11 will be generated during bending the flexible printed circuit board 12, and the pull force F separates the adhesive 14 from the frame 11 in a direction far away from the glass cover 10, so that adhesive failure occurs and the production quality is decreased.

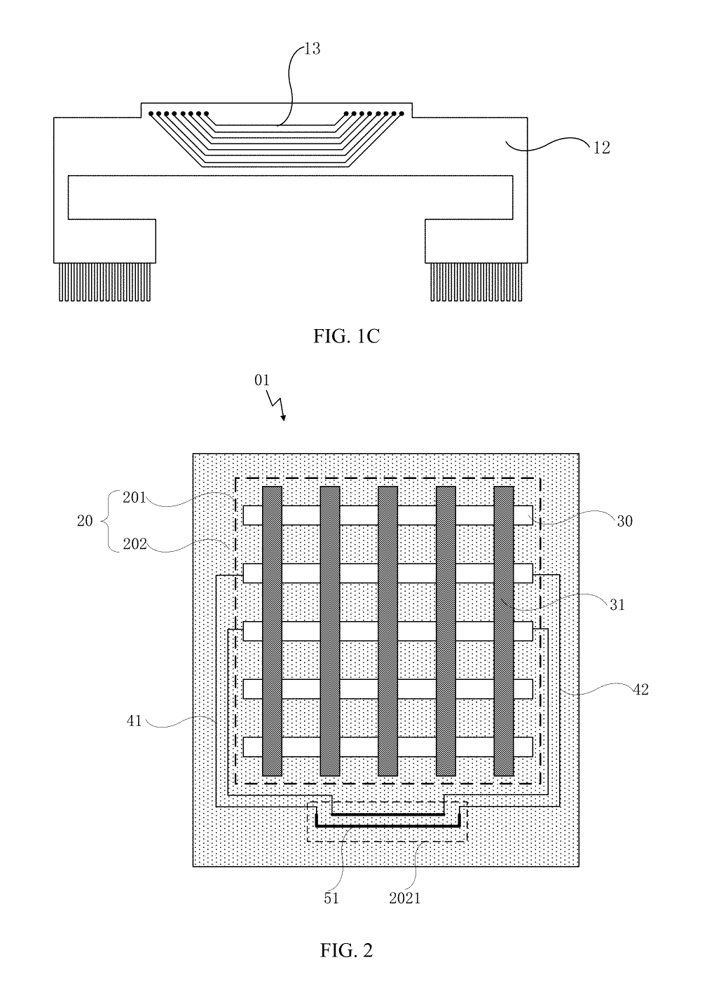

An embodiment of the disclosure provides a touch substrate 01 comprising a transparent base substrate 20, as illustrated in FIG. 2. The transparent base substrate 20 is divided to a touch region 201 and a peripheral region 202 surrounding the touch region 201.

In this case, on the transparent base substrate 20 and in the touch region 201, a plurality of first touch electrodes 30 and a plurality of second touch electrodes 31 which are intersected with and insulated from each other are provided.

It should be noted that, the above mentioned transparent base substrate 20 can be made of a transparent resin material, or transparent glass. When the touch panel is manufactured by the OGS process, the transparent base substrate 20 are a glass cover for covering the display panel, and the glass cover is integrated with the above mentioned first touch electrodes 30 and second touch electrodes 31.

In addition, the above mentioned first touch electrodes 30 can be touch drive electrodes TX (Transmit), and the second touch electrodes 31 can be touch sense electrodes RX (Receive); alternatively, the first touch electrodes 30 can be the touch sense electrodes RX (Receive), and the second touch electrodes 31 can be the touch drive electrodes TX (Transmit). This is not limited by the disclosure.

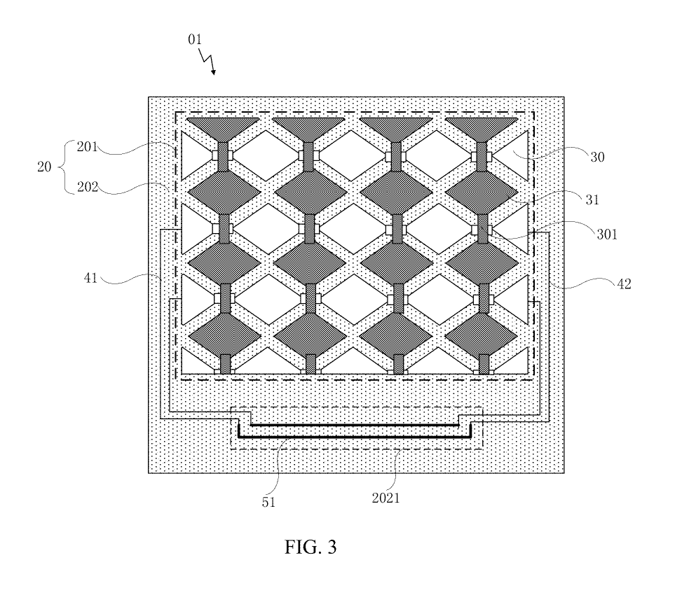

As illustrated in FIG. 2, the first touch electrodes 30 and the second touch electrodes 31 can be strip electrodes which are provided in different layers and are intersected with each other. Alternatively, as illustrated in FIG. 3, the transparent substrate 20 is provided with diamond electrodes which are provided in different layers and are arranged in a matrix. For the diamond electrodes in a first layer, every two adjacent diamond electrodes provided in the same row are connected by a connection layer 301, to constitute the above mentioned first touch electrodes 30. For the diamond electrodes in a second layer, two adjacent diamond electrodes provided in the same column are connected by a connection layer 301, to constitute the above mentioned second touch electrodes 31.

Here, the positional terms “row” and “column” etc. are defined with respect to the schematically illustrated orientation of the touch substrate 01 in the drawings. It should be understood that, these positional terms are relative concepts, which are used to description of the relative positions, and can correspondingly change according to the change of the position where the touch substrate is placed.

On this basis, on the transparent base substrate 20 and in the peripheral region 202, a first lead wire 41 for connecting an end of the first touch electrode 30 and a second lead wire 42 for connecting another end of the first touch electrode 30 are provided. Here, it should be noted that, two ends of at least one first touch electrode of the above mentioned touch substrate are connected with the first lead wire 41 and the second lead wire 42, respectively.

In addition, the above mentioned peripheral region 202 comprises a bond region 2021 for bonding to the flexible printed circuit board 12. In this case, on the above mentioned transparent base 20 and in the bond region 2011, a first connection line 51 for connecting a first lead wire 41 and a second lead wire 42 which are connected with the same first touch electrode 30 is provided.

Further, in order to simplify the process, the above mentioned first lead wire 41, second lead wire 42 and first connection line 51 are provided in the same layer and are made of the same material, so that the manufacture of the first connection line 51 can be completed during the manufacture of the first lead wire 41 and the second lead wire 42.

In such a way, voltages are input to the two ends of the first touch electrode by the first lead wire and the second lead wire respectively, and the voltages which are input to the two ends of the same first touch electrode which is connected with the first lead wire and the second lead wire by the first lead wire and the second lead wire respectively, are equal by using the first connection line, to avoid that the voltages at the two ends of the first touch electrode 31 are not equal due to the resistance of the first touch electrode itself when the first touch electrode is charged from one side. In addition, because the first connection line is provided on the transparent base substrate, the above mentioned first connection line is not required to be manufactured on the flexible printed circuit board which is connected with the touch substrate, so as to decrease the thickness of the flexible printed circuit board and reduce a bending rigidity of the flexible printed circuit board, to avoid the adhesive failure of the frame during bending the flexible printed circuit board due to the flexible printed circuit board being too thick.

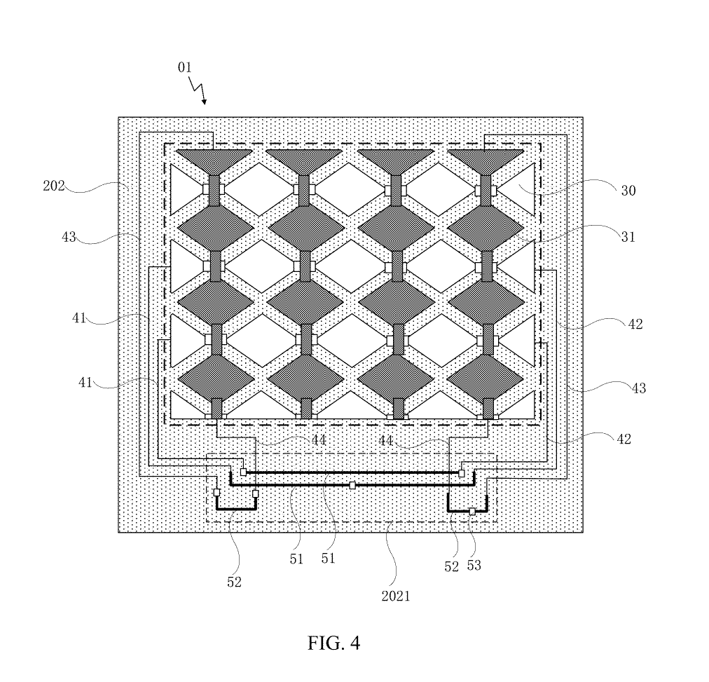

Further, in order to avoid that the voltages at the two ends of the second touch electrode 31 are not equal due to the resistance of the second touch electrode itself when the second electrode is charged from one side, as illustrated in FIG. 4, on the transparent base substrate 20 and in the peripheral region 202, a third lead wire 43 for connecting an end of the second touch electrode 31 and a fourth lead wire 44 for connecting another end of the second touch electrode 31 are provided.

On this basis, on the transparent base substrate 20 and in the bond region 2021, a second connection line 52 for connecting the third lead wire 43 and the fourth lead wire 44 which are connected with the same second touch electrode 31 is provided. Thus, voltages are input to two ends of the second touch electrode by the third lead wire 43 and the fourth lead wire 44 respectively, and the voltages which are input to the two ends of the same second touch electrode 31 which is connected with the third lead wire 43 and the fourth lead wire 44 by the third lead wire 43 and the fourth lead wire 44 respectively are equal by using the second connection line 52.

In should be noted that, in order to improve the signal transmission efficiency and decrease the signal loss during the signal transmission, the first lead wire 41, the second lead wire 42, the third lead wire 43, the first connection line 51 or the second connection line 52 can be made by metal materials.

Further, in order to simplify the process, the first lead wire 41, the second lead wire 42, the third lead wire 43 and the fourth lead wire 44 are provided in the same layer and made by a same material. Thus, the manufacture of the third lead wire 43 and the fourth lead wire 44 can be completed during the manufacture of the first lead wire 41 and the second lead wire 42. In this case, in order to avoid the signal crosstalk between the first touch electrode 30 and the second touch electrode 31, the first connection line 51 and the second connection line 52 are provided in different layers and are insulated from each other. At this time, when the first connection line 51 and the first lead wire 41 as well as the second lead wire 42 are made by the same material, the second connection line 52 and the first connection line 51 can be made by the same material, but are provided in different layers, and an insulation layer is provided between the second connection line 52 and the first connection line 51.

On this basis, because both of the second connection line 52 and the first connection line 51 are provided in the bond region 2021 of the transparent base substrate 20, the above mentioned second connection line 52 is not required to be manufactured on the flexible printed circuit board 12 which is connected with the touch substrate 01, so as to further decrease the thickness of the above mentioned flexible printed circuit board 12 and reduce the rigidity of the flexible printed circuit board 12.

Further, in order to connect the flexible printed circuit board 12 with the touch substrate 101, as illustrated in FIG. 4, a bond pin 53 is provided on the above mentioned bond region 2021, and the bond pin 53 and a bond pin on the flexible printed circuit board 12 can be attached to each other, to implement bonding to the flexible printed circuit board. A procedure of providing the bond pins 53 on the touch substrate 01 will be illustrated in details below.

In some example, with respect to connecting with the same touch electrode 30, for example, the above mentioned bond pin 53 can be provided on a connection position where the first lead wire 41 is connected with the first connection line 51, and the above mentioned bond pin 53 is also provided on a connection position where the second lead wire 42 is connected with the second connection line 51.

It should be noted that, the bond pin 53 herein is made of a metal material, and in order to simplify the manufacture process, the material of the bond pin 53 can be the same as that of the first lead wire 41 and the second lead wire 42, or the third lead wire 43 and the fourth lead wire 44.

Alternatively, for example, the first lead wire 41 and the second lead wire 42 share a bond pin 53.

Comparatively, the first lead wire 41 and the second lead wire 42 share a bond pin 53, which can decrease times of manufacturing the bond pins, to simplify the manufacture process. But, with respect to the solution in which the above mentioned bond pins 53 are provided on both the connection position where the first lead wire 41 is connected with the first connection line 51 and the connection position where the second lead wire 42 is connected with the first connection line 51, the bond pins 53 are provided on the above mentioned connection positions, so that each of the lead wires has an independent bond pin 53, to improve the signal transmission efficiency of transmitting signals from the flexible printed circuit board 12 to respective lead wires by respective bond pins and the signal stability. Therefore, the above mentioned two solutions have their advantages and disadvantages, and those skilled in related arts can select them according to practical production requirements.

Similarly, with respect to connecting with the same first touch electrode, as illustrated in FIG. 4, the providing manner of the above mentioned bond pins 53 can be that, the above mentioned bond pin 53 can be provided on a connection position where the third lead wire 43 is connected with the second connection line 52, and the above mentioned bond pin 53 is provided on a connection position where the fourth lead wire 44 is connected with the second connection line 52. Alternatively, the third lead wire 43 and the fourth lead wire 44 share a bond pin 53. The above mentioned two solutions also have the above beneficial effects which will not be repeated here.

A method of arranging the above mentioned lead wires, connection lines and bond pins 53 on the transparent base substrate 20 on which the first touch electrode 30 and second touch electrode 30 are provided will be described in details below.

Firstly, a wiring space of the first lead wire 41 and the second lead wire 42 for connecting two ends of the same first touch electrode 30 respectively is determined according to a number of the bond pins for bonding to the flexible printed circuit board 12 to provide a voltage to the first touch electrode 30. In addition, when two ends of the same second touch electrode 31 are also required to connect with the third lead wire 43 and the fourth lead wire 44, a wiring space of the above mentioned third lead wire 43 and the fourth lead wire 44 is determined according to a number of the bond pins for bonding to the flexible printed circuit board 12 to provide a voltage to the second electrode 31.

Next, the line width and the line spacing of respective lead wires (the first lead wire 41, the second lead wire 42, the third lead wire 43 and the fourth lead wire 44) are determined according to the above mentioned wiring spaces.

Finally, the above mentioned lead wires are formed in the peripheral region 202 according to the above mentioned determined line width and line spacing.

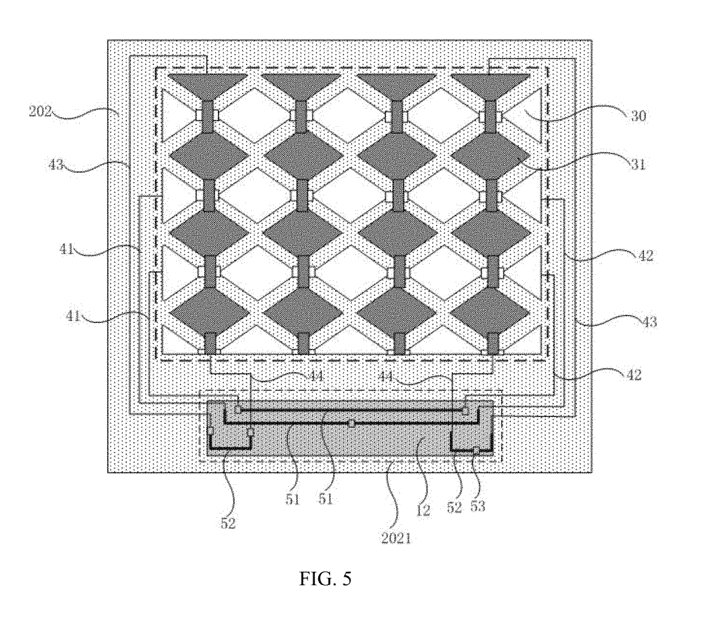

An embodiment of the disclosure provides a touch panel, as illustrated in FIG. 5, comprising any of the above mentioned touch substrates 01, and a flexible printed circuit board 12 is bonded to a bond region 2021 of the touch substrate. In addition, the touch panel further comprises a frame 11 mounted on the touch substrate 01, as illustrate in FIG. 1A, to protect the periphery of the touch substrate 01. The touch substrate 01 of the above mentioned touch panel has the same structure and the same beneficial effects as the touch substrate 01 provided by previously mentioned embodiments, which will not be repeated here.

An embodiment of the disclosure provides a touch display device, comprising the above mentioned touch panel. For example, the touch display device comprises a display panel, and the above mentioned touch panel can cover a light emit side of the display panel. The beneficial effects of the touch display device are mentioned above, and will not be repeated here.

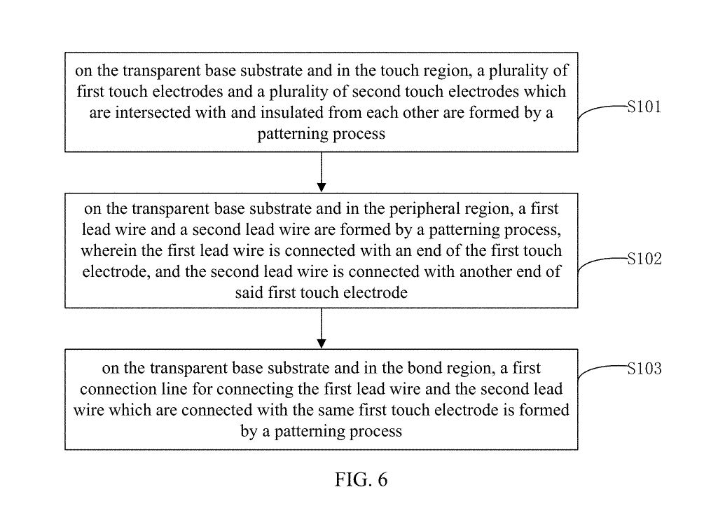

An embodiment of the disclosure provides a manufacturing method of a touch substrate. As illustrated in FIG. 2, the touch substrate 01 comprises the transparent base substrate 20, and the transparent base substrate 20 is divided into a touch region 201 and a peripheral region 202. In addition, the peripheral region 202 comprises a bond region 2021 for bonding to the flexible printed circuit board 12. In this case, as illustrated in FIG. 6, a manufacturing method of the above mentioned touch substrate comprise the following steps.

S101, as illustrated in FIG. 2, on the transparent base substrate 20 and in the touch region 201, a plurality of first touch electrode 30 and a plurality of second touch electrode 31 which are intersected with and insulated from each other are formed by a patterning process.

S102, on the transparent base substrate 20 and in the peripheral region 202, a first lead wire 41 and a second lead wire 42 are formed by a patterning process. The first lead wire 41 is connected with an end of the first touch electrode 30, and the second lead wire 42 is connected with another end of the first touch electrode 30.

S103, on the transparent base substrate 20 and in the bond region 2021, a first connection line 51 for connecting the first lead wire 41 and the second lead wire 42 which are connected with the same first touch electrode 30 is formed by a patterning process.

Further, in order to simplify the process, the above mentioned first lead wire 41, the second lead wire 42 and the first connection 51 can be formed by one patterning process, so that the manufacture of the first connection line 51 can be completed during the manufacture of the first lead wire 41 and the second lead wire 42.

In such a way, voltages are input to the two ends of the first touch electrode by the first lead wire and the second lead wire respectively, and the voltages which are input to the two ends of the same first touch electrode which is connected with the first lead wire and the second lead wire by the first lead wire and the second lead wire respectively, are equal by using the first connection line, to avoid that the voltages at the two ends of the first touch electrode 31 are not equal due to the resistance of the first touch electrode itself when the first electrode is charged from one side. In addition, because the first connection line is provided on the transparent base substrate, the first connection line is not required to be manufactured on the flexible printed circuit board which is connected with the touch substrate, so as to decrease the thickness of the flexible printed circuit board and reduce a bending rigidity of the flexible printed circuit board, to avoid the adhesive failure of the frame during bending the flexible printed circuit board due to the flexible printed circuit board being too thick.

It should be noted that, in the disclosure, the patterning process can comprise the lithographic process or comprise the lithographic process and the etch step, and meanwhile, it can further comprise printing, ink-jet and others which are used to form a predetermined pattern. The lithographic process refers to a pattern forming process by utilizing photoresist, a mask and an exposure machine etc, which may include film formation, exposure and development and the like. The corresponding patterning process can be selected according to a structure formed in the disclosure.

The one patterning process of the embodiment of the disclosure refers to a process of forming different exposure regions by one mask exposure process and then performing removing process, such as multiple etching and ashing etc., on the different exposure regions, to obtain a desired pattern.

Further, in order to avoid that the voltages at the two ends of the second touch electrode 31 are not equal due to the resistance of the second touch electrode 31 itself when the second electrode is charged from one side, the above mentioned manufacturing method further comprises: on the transparent base substrate 20 and in the peripheral region 202, forming a third lead wire 43 and a fourth lead wire 44 by a patterning process. The third lead wire 43 is connected with an end of the second touch electrode 31 and the fourth lead wire 44 is connected with another end of the second touch electrode 31.

In addition, on the transparent base substrate 20 and in the bond region 2021, a second connection line 52 for connecting the third lead wire 43 and the fourth lead wire 44 which are connected with the same second touch electrode 31 is formed by a patterning process. Thus, voltages are input to the two ends of the second touch electrode by the third lead wire 43 and the fourth lead wire 44 respectively, and the voltages which are input to the two ends of the same second touch electrode 31 which is connected with the third lead wire 43 and the fourth lead wire 44 by the third lead wire 43 and the fourth lead wire 44 respectively are equal by using the second connection line 52.

What are described above is related to the illustrative embodiments of the disclosure only and not limitative to the scope of the disclosure; the scopes of the disclosure are defined by the accompanying claims.

This application claims the priority of Chinese Patent Application No. 201610622091.1 filed on Aug. 1, 2016, which is hereby incorporated entirely herein by reference.

1. A touch substrate, comprising:
a transparent base substrate, including a touch region and a peripheral region surrounding the touch region;
a first touch electrode and a second touch electrode, intersected with and insulated from each other, and disposed in the touch region on the transparent base substrate;
a first lead wire and a second lead wire, disposed in the peripheral region on the transparent base substrate, the first lead wire being connected with an end of the first touch electrode, and the second lead wire being connected with another end of the first touch electrode; and
a first connection line, connecting the first lead wire and the second lead wire which are connected with the first touch electrode,
wherein the peripheral region comprises a bond region for bonding to a flexible printed circuit board and the first connection line is disposed in the bond region on the transparent base substrate.

2. The touch substrate of claim 1, wherein the first lead wire, the second lead wire and the first connection line are provide in a same layer and are made of a same material.

3. The touch substrate of claim 1, further comprising:
a third lead wire and a fourth lead wire, disposed in the peripheral region on the transparent base substrate, the third lead wire being connected with an end of the second touch electrode, and the fourth lead wire being connected with another end of the second touch electrode; and
a fourth connection line, connecting the third lead wire and the fourth lead wire which are connected with the second touch electrode, and disposed in the bond region on the transparent base substrate.

4. The touch substrate of claim 3, wherein the first lead wire, the second lead wire, the third lead wire and the fourth lead wire are disposed in the same layer and are made of the same material, and the first connection line and the second connection line are disposed in different layers and are insulated from each other.

5. The touch substrate of claim 1, wherein a bond pin is disposed on a connection position where the first lead wire is connected with the first connection line, and the bond pin is disposed on a connection position where the second lead wire is connected with the first connection line.

6. The touch substrate of claim 1, wherein the first lead wire and the second lead wire share one bond pin.

7. The touch substrate of claim 3, wherein a bond pin is disposed on a connection position where the third lead wire is connected with the second connection line, and the bond pin is disposed on a connection position where the fourth lead wire is connected with the second connection line,

8. The touch substrate of claim 3, wherein the first lead wire and the second lead wire share one bond pin.

9. A touch panel, comprising the touch substrate of claim 1, wherein a flexible printed circuit board is bonded to the bond region of the touch substrate.

10. A touch display device, comprising:
the touch panel of claim 9; and
a display panel,
wherein the touch panel is provided on a light emitting side of the display panel.

11. A manufacturing method of a touch substrate, comprising;
providing a transparent base substrate, which includes a touch region and a peripheral region surrounding the touch region;
forming a first touch electrode and a second touch electrode in the touch region on the transparent base substrate, the first touch electrode and the second touch electrode being intersected with and insulated from each other;
forming a first lead wire and a second lead wire in the peripheral region on the transparent base substrate, wherein the first lead wire is connected with an end of the first touch electrode, and the second lead wire is connected with another end of the first touch electrode; and
forming a first connection line in the bond region on the transparent base substrate, the first connection line connecting the first lead wire and the second lead wire which are connected with the first touch electrode.

12. The manufacturing method of the touch substrate of claim 11, further comprising:
forming a third lead wire and a fourth lead wire in the peripheral region on the transparent base substrate, wherein the third lead wire is connected with an end of the second touch electrode, and the fourth lead wire is connected with another end of the second touch electrode; and
forming a second connection line in the bond region on the transparent base substrate, the second connection line connecting the third lead wire and the fourth lead wire which are connected with the second touch electrode.

13. The touch panel of claim 9, wherein the first lead wire, the second lead wire and the first connection line are provide in a same layer and are made of a same material.

14. The touch panel of claim 9, further comprising:
a third lead wire and a fourth lead wire, disposed in the peripheral region on the transparent base substrate, the third lead wire being connected with an end of the second touch electrode, and the fourth lead wire being connected with another end of the second touch electrode; and
a fourth connection line, connecting the third lead wire and the fourth lead wire which are connected with the second touch electrode, and disposed in the bond region on the transparent base substrate.

15. The touch panel of claim 14, wherein the first lead wire, the second lead wire, the third lead wire and the fourth lead wire are disposed in the same layer and are made of the same material, and the first connection line and the second connection line are disposed in different layers and are insulated from each other.

16. The touch panel of claim 9, wherein a bond pin is disposed on a connection position where the first lead wire is connected with the first connection line, and the bond pin is disposed on a connection position where the second lead wire is connected with the first connection line.

17. The touch panel of claim 9, wherein the first lead wire and the second lead wire share one bond pin.

18. The touch panel of claim 14, wherein a bond pin is disposed on a connection position where the third lead wire is connected with the second connection line, and the bond pin is disposed on a connection position where the fourth lead wire is connected with the second connection line.

19. The touch panel of claim 14, wherein the first lead wire and the second lead wire share one bond pin.
